(19) United States
(12) Patent Application Publication
(10) Pub. No.: US 2024/0365165 A1
(43) Pub. Date: Oct. 31, 2024

(54) LOSSLESS HANDOVER OF MULTICAST BROADCAST SERVICES

(71) Applicant: ZTE Corporation, Shenzhen (CN)

(72) Inventors: Tao QI, Shenzhen (CN); Lin CHEN, Shenzhen (CN); Yang LI, Shenzhen (CN); Zhendong LI, Shenzhen (CN)

(21) Appl. No.: 18/764,669

(22) Filed: Jul. 5, 2024

Related U.S. Application Data
(63) Continuation of application No. PCT/CN2022/070445, filed on Jan. 6, 2022.

(51) Int. Cl. H04W 28/02; H04W 76/40

(52) U.S. Cl. CPC H04W 28/0268; H04W 76/40

(57) ABSTRACT

Methods, apparatus and systems for wireless communication are described. One method includes receiving, by a network device of a wireless network, an indication to perform N one-to-one mappings, wherein each mapping is between a Quality of Service (QoS) flow and a radio bearer, wherein N is a positive integer and controlling communication in the wireless network according to the indication.

### CROSS-REFERENCE TO RELATED APPLICATION

This application is a continuation and claims priority to International Application No. PCT/CN2022/070445, filed on Jan. 6, 2022, the disclosure of which is hereby incorporated by reference herein in its entirety.

### TECHNICAL FIELD

This patent document is directed generally to wireless communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that enable a lossless handover of a Multicast and Broadcast Service.

In one example aspect, a method for data communication includes receiving, by a network device of a wireless network, an indication to perform N one-to-one mappings, wherein each mapping is between a Quality of Service (QoS) flow and a radio bearer, wherein N is a positive integer and controlling communication in the wireless network according to the indication.

In another example aspect, a method for data communication includes communicating, from a session management function for multicast broadcast services (MBS), to a user plane function, an indication that for a certain MBS QoS flow, there is a sequence number per QoS flow in a General Radio Packet Service Tunneling Protocol User plane (GTP-U) header.

In another example aspect, a method for wireless communication includes receiving, from a session management function for multicast broadcast services by a user plane function, an indication that the user plane function is to use a general packet radio services tunnel user plane information for a one-to-one mapping between N specified Quality of Service (QoS) flows and N radio bearers and configuring operation of the user plane function according to the indication.

In another example aspect, a method for wireless communication includes receiving, by a session management function of a wireless network, a configuration from a multicast broadcast session management function, wherein the indication identifies N one-to-one mappings, where N is a positive integer and operating the session management function according to the configuration.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1 illustrates an example of a QoS flow to a radio bearer or MRB mapping rule, example.

FIG. 2 illustrates examples of messages exchanged in a data network.

FIG. 3 illustrates an example of a message exchange.

FIG. 4 illustrates an example of a message exchange.

FIG. 5 is a flowchart of an example of a data communication method.

FIGS. 6A-6C show flowcharts of example methods of data communication.

FIG. 7 shows an example of a wireless communication system where techniques in accordance with one or more embodiments of the present technology can be applied.

FIG. 8 is a block diagram representation of a portion of a radio station in accordance with one or more embodiments of the present technology can be applied.

### DETAILED DESCRIPTION

Section headings are used in the present document to improve readability and do not limit scope of the disclosed embodiments and techniques to only that section. Certain features are described using the example of Fifth Generation (5G) wireless protocol. However, applicability of the disclosed techniques is not limited to only 5G wireless systems.

For LTE (Long Term Evolution) eMBMS (Multimedia Multicast Broadcast Service), a network aims only at best effort service continuity for eMBMS, that is to say, service interruption, service suspension, data loss or data duplication delivered to application layer can happen when UE is roaming among different RAN nodes, or eNBs.

In 5G NR (New Radio) MBS (Multicast Broadcast Service), for MBS or multicast services, network-controlled service continuity is achieved to allow the service to continue even when UE is handed over to a RAN (Radio Access Network) node without the MBS service before UE is handed over. To further minimize potential data loss during the mobility, and/or even prevent duplicated data packets delivered to higher layer, one possible solution is to have a coordinated data sequence number at a radio bearer level, or Packet Data Convergence Protocol Sequence Number (PDCP SN) is synchronized between the source RAN node and target RAN node for one specific MRB.

That is to say, for network awareness of data loss, e.g., network being able to be aware of the data loss and/or whether duplicated data is sent to upper layer, for example, network is aware of the delivery status for the MRB by PDCP status report/PDCP SR, among network nodes, there needs to be a unified sequence number for one MRB or PDCP SN for such MRB is synchronized, such kind of the synchronization might be only applied to RAN nodes in one specific region, e.g., covered by the same Multimedia Broadcast User Plane Function MB-UPF).

One of the solutions is
to have one-to-one mapping from the QoS flow to MRB. That is, for one MRB there is only one QoS flow of the MBS session is mapped to such MRB. and
RAN nodes derives the PDCP SN of the MRB based on a common sequence number from 5G core network. The sequence number from 5GC can be from the N3 GTP-U (GPRS Tunneling Protocol user plane) header for each QoS flow, the N3 tunnel is for the shared delivery of MBS session data from MB-UPF to RAN node. The per QoS flow sequence number can be existing DL QFI Sequence Number on N3 GTP-U header or GTP-U Extension Header, or new Sequence Number on N3 GTP-U header or GTP-U Extension Header for each QoS flow.

For such a QoS flow that requires one-to-one mapping to one specific MRB, if it is asked that for all QoS flow of the MBS session to be treated by above mechanism, there might be issues as below:
the total number of the resulted MRB is beyond UE capability, since there might be more than one QoS flow associated with the MBS session and the UE might be interested in more than one MBS session. Meanwhile, the maximum number of radio bearer can be configured to a UE has a limitation. And for some UEs, the total number of configured MRB and/or DRBs should not exceed a value defined by UE capability.
there are overhead for network and UE to be configured with extra MRBs, even the related QoS flow does not need lossless delivery during UE HO events. Configuring and maintaining extra radio bearer on both network and UE side requires extra efforts.

The present document discloses solutions that can be used by embodiments to overcome potential design risks as above, among other problems.

To minimize, or eliminate, the data packed loss for a multicast and broadcast service (MBS) during a handover HO and in other scenarios, e.g., when a wireless device such as a user equipment UE is handed over from a first radio access network RAN node (source RAN node) to the second RAN node (target RAN node), one solution is presented: for selective QoS flow of the MBS session, it is mapped to MRB in a one-to-one mapping rule, while for other QoS flows, they are mapped to MRBs flexibly by RAN node, i.e., without one-to-one mapping limitation.

### Terminology

Service layer or application layer might be used interchangeably in this document, it is used to indicate the layer that is other than, e.g., the access layer in 3GPP.

For MBS included in the document, it can mean Broadcast communication service and/or Multicast communication service.

For Broadcast communication service or Broadcast service, the same service and the same specific content data are provided simultaneously to all UEs in a geographical area (e.g., all UEs in the broadcast coverage area are authorized to receive the data). A broadcast communication service is delivered to the UEs using broadcast session. A UE can receive broadcast communication service in RRC_IDLE, RRC_INACTIVE and RRC_CONNECTED state.

For Multicast communication service or Multicast service, the same service and the same specific content data are provided simultaneously to a dedicated set of UEs (i.e., not all UEs in the multicast coverage area are authorized to receive the data). A multicast communication service is delivered to the UEs using multicast session. A UE can receive multicast communication service in RRC_CONNECTED and RRC_INACTIVE state possibly with mechanisms such as point-to-point PTP delivery, and/or HARQ feedback/retransmission.

NR MBS or 5G MBS or MBS might be used interchangeably to describe the feature or technique set in 3GPP to support MBS in 5G system or specifically in NG-RAN.

MBS and MBS service might be used interchangeably to describe one specific Multicast or Broadcast service.

MBS can also be used to describe a service type, i.e., Multicast and Broadcast Service, either it is in NR, or in LTE, or in any other wireless communication systems. Another service type is Unicast service, e.g., Unicast service is already covered in NR Release 15.

MBS Radio Bearer, or MRB: A radio bearer that is configured for MBS delivery.

eMBMS can be the feature or technique set in 3GPP to support MBS in EPS/LTE, or the service type of Multicast and Broadcast Service.

MBS ID in this document could be TMGI, or IP Multicast address (with or without source address), or any other unique ID to identify the MBS service.

RAN, or RAN node. Radio access network, can be a gNB, or any other access network (AN) node.

PDCP, Packet Data Convergence Protocol

SDU, Service Data Unit

PDU, Packet Data Unit

SN, Sequence Number

Some embodiments may be implemented to have a selective QoS flow (or flows) to follow the one-to-one mapping to the MRB, that is to say, for other QoS flow, RAN node can flexibly decide the mapping rule. In the following text, we call the QoS flow that one-to-one mapping rule applies, or the QoS flow that lossless HO is needed, which can be of the same meaning.

With respect to the issue of how to indicate to RAN node which QoS flow will apply the one-to-one mapping rule, some embodiments may be as follows.

From RAN node perspective, it should be aware which QoS flow shall apply the one-to-one mapping rule, and which shall not (i.e., have a flexible mapping). The one-to-one mapping rule applies to achieve lossless HO for specific QoS flows or specific MBS services.

Two solutions are possible.

### #User Plane Solution

In this solution, RAN node decides for one specific QoS flow, based on whether the per QoS flow sequence number exists. The per sequence number can be
DL QFI Sequence Number on N3 GTP-U header or GTP-U Extension Header, or
new Sequence Number on N3 GTP-U header or GTP-U Extension Header for each QoS flow.

If there is such per QoS flow SN for one specific QoS flow on the N3 tunnel for such MBS session, RAN node maps such QoS flow to an MRB in a one-to-one manner. If there is no such per QoS flow SN for such QoS flow, RAN node decide the mapping rule flexibly by itself.

### #CONTROL PLANE SOLUTION

In this solution, RAN node decides for one specific QoS flow, based on the MBS session information, for example, the session management information for the MBS session. In one of the examples, the MBS session is associated with one PDU session for the UE. In the PDU session management information, the QoS flow that one-to-one mapping applies is indicated for such QoS flow, e.g., an indicator is carried for such QoS flow in the PDU Session Resource Setup Request Transfer, PDU Session Resource Modify Request Transfer, Multicast Session Update procedure, Multicast Session Activation procedure or any other Information element in the control information from SMF or MB-SMF.

In above session management signaling,
there might be per UE PDU session information which includes the QoS flow information of the per UE PDU session,
there might be per MBS session information which includes the QoS flow information of the per MBS session,
there might be the mapping information which indicates how the QoS flow of the MBS session is mapped to or associated to the QoS flow of the per UE PDU session,

The indicator for specific QoS that one-to-one mapping applies could be indicated in one or more than one above information associated with that QoS flow.

With respect to the issue of RAN behavior for QoS flow to radio bearer mapping, some embodiments may be as follows.

In some embodiments, RAN node decides that for one identified specific QoS flow, based on the either solutions of above (e.g., User plane solutions or control plane solutions). Only for identified QoS flow, the one-to-one mapping rule applies; while for other QoS flow, RAN node decides flexibly the mapping rule independently for each RAN node, e.g., there is no strict 1:1 relation between QoS Flows and AN (access network) resources, i.e., MRB, it is up to the AN, e.g., RAN node, to establish the necessary AN resources that QoS Flows can be mapped to, and to release them.

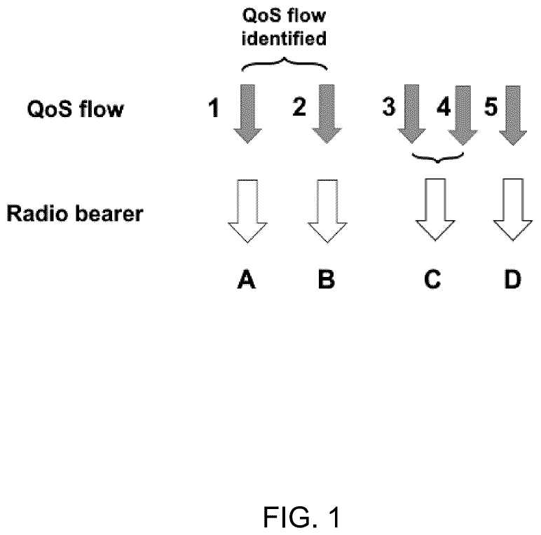

FIG. 1 depicts in embodiment example in which QoS flow 1 and QoS flow 2 are identified by RAN node that the one-to-one mapping rule shall apply, either through the User plane solution or control plane solution. Therefore, only QoS flow 1 is mapped to MRB A, and only QoS flow 2 is mapped to MRB B. While for other QoS flows, like QoS flow 3, 4, and 5, RAN node decides the mapping rule independently, for example, QoS flow 3 and 4 are mapped to MRB C, while QoS flow 5 is mapped to MRB D. Other options are possible, for example, QoS flow 3, 4, and 5 are all mapped to a single MRB. It might depend on the available resource of the RAN node, UE capability or other information in access layer.

With respect to the issue of how to determine ID of the MRB, some embodiments are as follows.

For the QoS flow that need one-to-one mapping, RAN node maps such QoS flow to one MRB. The MRB ID could be determined by the following rule:
the MRB ID is derived from the QFI (QoS Flow Identifier) of QoS flows that need one-to-one mapping,

How the MRB ID is derived can be
the QFI of the QoS flow that need one-to-one mapping are continuous, the MRB ID could be equal to the QFI;
or, the QoS flows can be indexed by the rank of its QFI, the MRB ID then is further derived from the index. For example, for MBS QoS flows that need one-to-one mapping whose QFI is 2, 4, 7, and 11. The index of which can be 1, 2, 3, and 4 if we follow the ranking rule from smaller to larger. Therefore, the MRB ID of the corresponding QoS flow which is mapped to the MRB, can be 1, 2, 3, and 4. Other deriving rules are not excluded.

With respect to the issue of RAN behavior during UE handover, some embodiments are as follows.

If there is any data forwarding requirement for the MRB to reduce the data loss during HO, it only applies to certain MRB which QoS flow that one-to-one mapping applies is mapped to. Therefore, only for such MRB, the source NG-RAN node may propose to perform forwarding of downlink data. For other MRBs, the forwarding of downlink data will not be proposed.

With respect to the issue of how MB-UPF gets notified by MB-SMF of the one-to-one mapping, some embodiments are as follows.

SMF (SMF or MB-SMF) informs MB-UPF therefore MB-UPF applies the per QoS flow sequence number on the GTP-U header or extension header to certain MBS QoS flows. Such information can be indicated in the MBS Session N4 Control Information, e.g. there is an indicator for certain MBS QoS flow, that there should be a per QoS flow sequence number in the GTP-U header or extension header. The per QoS flow sequence number can be
DL QFI Sequence Number on N3 GTP-U header or GTP-U Extension Header, or
new Sequence Number on N3 GTP-U header or GTP-U Extension Header for each QoS flow.

UPF behaviour. Only for such indicated QoS flow, UPF will carry the per QoS flow SN in the GTP-U tunnel on N3 GTP-U header or GTP-U Extension Header to distribute the MBS data to RAN node, the per QoS flow sequence number could be carried as in above two solutions.

With respect to the issue of how SMF gets notified by MB-SMF of the one-to-one mapping, some embodiments are as follows.

In some embodiments, when configured with the control plane solution disclosed above, the RAN node is informed by SMF to tell which QoS flow is to be mapped to one MRB in one-to-one manner.

SMF may be indicated by MB-SMF such information, if SMF and MB-SMF are separate, for example, SMF and MB-SMF are separately deployed. Therefore, in the N16mb interface, or in the interactions between SMF and MB-SMF, for the QoS flow that one-to-one mapping applies, there is an indicator associated with the QoS flow from MB-SMF to notify SMF. SMF may further notify RAN node in the session management signaling.

With respect to the issue of how a gNodeB (gNB) implements a packet discarding mechanism, some embodiments are as follows.

For legacy 5G NR (new radio) design, for one data radio bearer, when the discardTimer expires for a PDCP SDU, or the successful delivery of a PDCP SDU is confirmed by PDCP status report, the transmitting PDCP entity shall discard the PDCP SDU along with the corresponding PDCP Data PDU. If the corresponding PDCP Data PDU has already been submitted to lower layers, the discard is indicated to lower layers.

For example, if one radio bearer is of AM (acknowledge mode), network may discard the PDCP SDU if the successful delivery of a PDCP SDU is confirmed by PDCP status report; for one radio bearer of UM (Un-Acknowledged Mode), network may discard the PDCP SDU if the corresponding PDCP Data PDU has already been submitted to lower layers.

In case of gNB-CU and gNB-DU split deployment scenarios, the node hosting the NR PDCP entity, e.g., gNB-CU, when receiving the DL DATA DELIVERY STATUS frame: is allowed to remove the buffered NR PDCP PDUs of a RLC AM bearer, according to the feedback of successfully delivered NR PDCP PDUs. In case of RLC AM, after the highest NR PDCP PDU sequence number successfully delivered in sequence is reported to the node hosting the NR PDCP entity, the corresponding node removes the respective NR PDCP PDUs. For RLC UM, the corresponding node may remove the respective NR PDCP PDUs after transmitting to lower layers.

However, for NR MBS,
RAN nodes or gNB-CU might not discard the NR PDCP SDU even the successful delivery of a PDCP SDU is confirmed by PDCP status report or the PDCP PDU has already been submitted to lower layer.
gNB-CU might not discard NR PDCP PDU, upon reception of the feedback of successfully delivered NR PDCP PDUs or respective NR PDCP PDUs have been transmitting to lower layers

Instead RAN nodes or gNB-CU might discard the NR PDCP SDU or NR PDCP PDU based on the QoS characteristics, of the radio bearer or the QoS flows. The packet data is still buffered at the RAN nodes or gNB-CU. In such case, data forwarding might be not needed between source RAN node and target RAN node.

Some preferred embodiments may implement the following listed technical solutions.

For example, a RAN node (e.g., a base station or a RAN node in which a UE currently is operating) may preferably implement the following solutions.

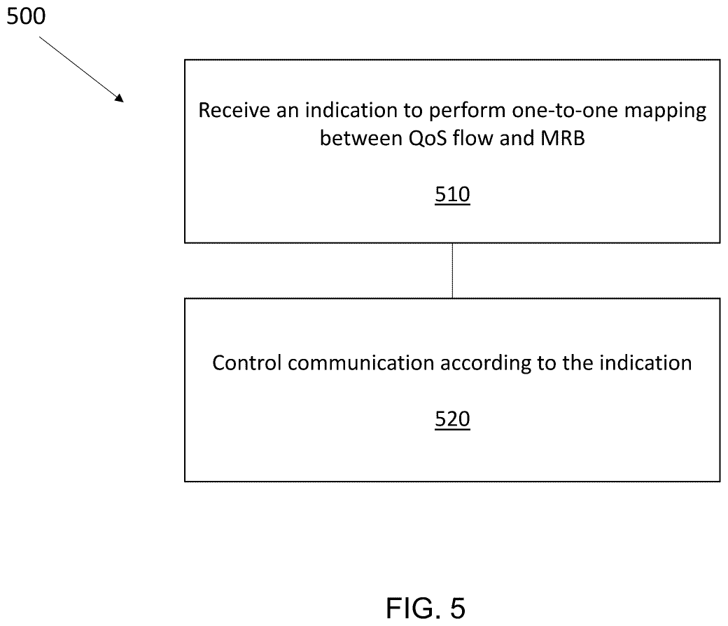

1. A method of data communication (e.g., method 500 depicted in FIG. 5), comprising: receiving (510), by a network device of a wireless network, an indication to perform N one-to-one mappings, wherein each mapping is between a Quality of Service (QoS) flow and a radio bearer, wherein N is a positive integer; and controlling (520) communication in the wireless network according to the indication. In some embodiments, a single mapping may be received, specifying a mapping between a specific QoS flow and a specific radio bearer. In some embodiments, e.g., as previously disclosed, less than all the radio bearers configured for a UE may be mapped using the one-to-one mapping.

2. The method of solution 1, wherein the indication comprises a user plane indication for the N one-to-one mappings.

3. The method of solution 2, wherein the user plane indication specifies that the N one-to-one mappings are determined according to whether a per-QoS flow sequence number exists.

4. The method of solution 3, wherein, the per-QoS flow sequence number is used for the one-to-one mapping.

5. The method of any of solutions 2-4, wherein the per-QoS flow sequence number is a QoS flow identifier (QFI) sequence number in a header or a dedicated sequence number for the QoS flow in a header of the packet data on a General Radio Packet Service Tunneling Protocol User Plane GTP-U tunnel.

6. The method of solution 1, wherein the indication comprises a control plane indication for the N one-to-one mappings such that the N one-to-one mappings are determined according to a session information associated with a multicast broadcast services (MBS) session.

7. The method of solution 6, wherein the session information comprises an indicator for the QoS flow in a protocol data unit, PDU, Session Resource Setup Request Transfer, a PDU Session Resource Modify Request Transfer, or another Information element in the control information from a session management function (SMF) or a multicast broadcast SMF (MB-SMF).

8. The method of solution 6, wherein the session information comprises an indicator for the QoS flow in a Multicast Session Update procedure, a Multicast Session Activation procedure or any Information element in the control information from a Multicast and Broadcast session management function (MB-SMF).

9. The method of any of the above solutions, wherein a rule is used to determine identities of the N radio bearers to which the one-to-one mapping is performed.

10. The method of solution 9, wherein the rule specifies deriving identities of the N radio bearers from QoS flow identifier of corresponding QoS flows for which the one-to-one mapping is indicated.

11. The method of solution 10, wherein the QoS flow identifiers are continuous, and the identities of the N radio bearers are determined to be equal to the corresponding QoS flow identifiers.

12. The method of solution 10, wherein, the identities of the N radio bearers are determined by indexing according to ranks of QoS flow identifiers.

13. The method of any of the above solutions, wherein the controlling the communication includes: performing the N one-to-one mappings to the N QoS flows according to the indication; and determining mappings between remaining QoS flows and radio bearers.

14. The method of any of solutions 1-13, wherein the controlling the communication includes, for a user device, performing a handover to a target network node by proposing data forwarding for radio bearers which are associated with QoS flows according to the one-to-one mapping.

15. The method of solution 14, further including, for the handover, refraining from proposing data forwarding for QoS flows for which no one-to-one mapping is performed.

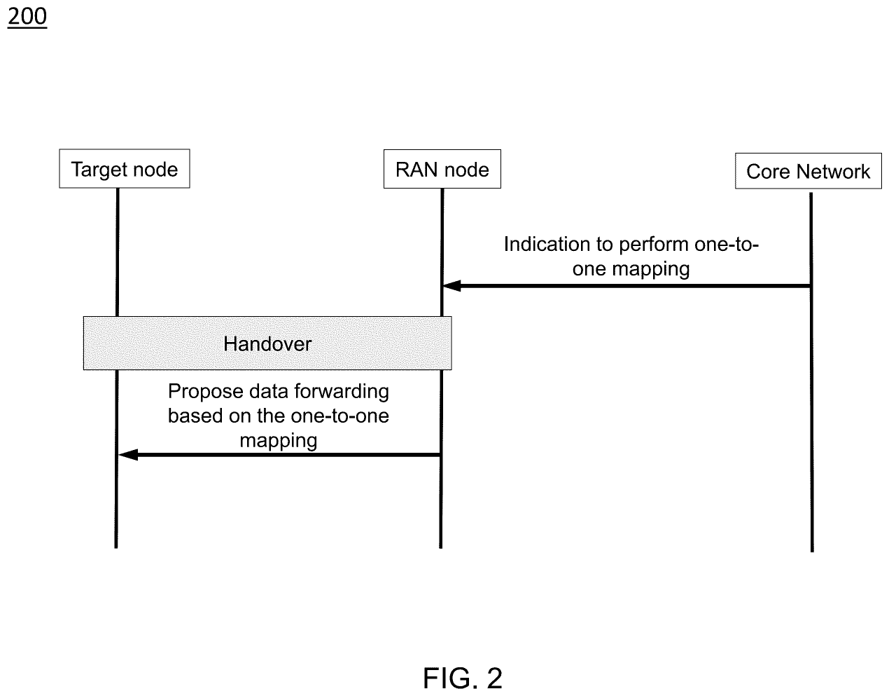

FIG. 2 shows a signal exchanges diagram that implements, for example, the method 500. A RAN node may receive an indication to perform one-to-one from a core network. Subsequently, to facilitate handoff of a UE, the RAN node may propose to a target node. data forwarding during handover based on the one-to-one mapping. Other possibly embodiments and features are disclosed throughout the present document.

For example, an MB-SMF function may preferably implement the following solutions.

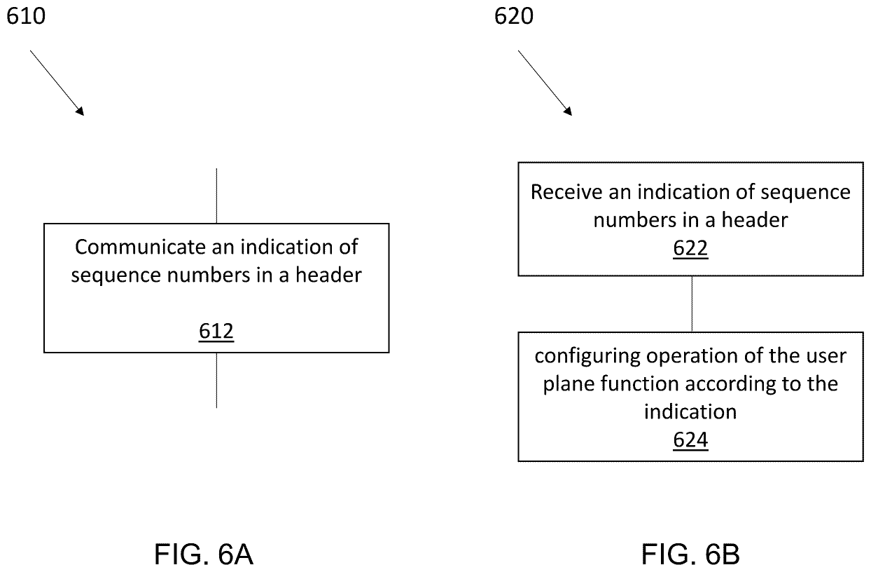

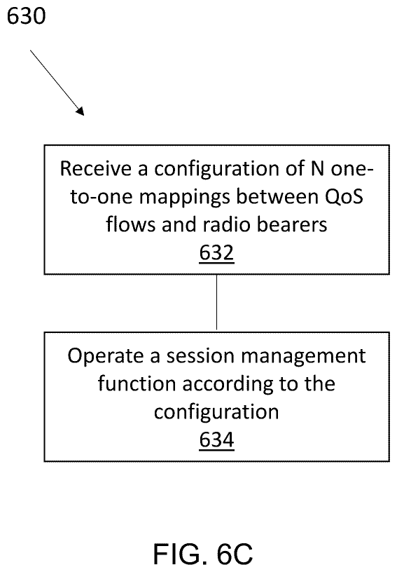

16. A method of data communication (e.g., method 610 depicted in FIG. 6A) comprising: communicating (612), from a session management function for multicast broadcast services (MBS) to a user plane function, an indication that, for a certain MBS Quality of Service (QoS) flow, there is a sequence number per QoS flow in a General Radio Packet Service Tunneling Protocol User plane (GTP-U) header.

17. The method of solution 16, wherein the indication is communicated in a multicast broadcast service session control information message.

18. The method of solutions 16-17, wherein the sequence number comprises a QoS flow identifier (QFI) sequence number in a header or an extension header on an N3 General Radio Packet Service Tunneling Protocol User plane (GTP-U) tunnel associated with the MBS session.

19. The method of solution 18, wherein the sequence number is a dedicated sequence number in a header or an extension header.

20. The method of any of solutions 16-19, wherein the session management function for multicast broadcast services communicates identities of the N QoS flows to which the one-to-one mapping is applied.

For example, an MB-UPF may preferably implement the following solutions.

21. A method of data communication (e.g., method 620 depicted in FIG. 6B), comprising: receiving (622), from a session management function for multicast broadcast services by a user plane function, an indication that the user plane function is to use a general packet radio services tunnel user plane information for a one-to-one mapping between N specified Quality of Service (QoS) flows and N radio bearers; and configuring (624) operation of the user plane function according to the indication.

22. The method of solution 21, wherein the indication is communicated in a multicast broadcast service session control information message.

23. The method of any of solutions 21-22, wherein the indication specifies that a sequence number is to be used for the one-to-one mapping.

24. The method of solution 23, wherein the sequence number comprises a QOS flow identifier (QFI) sequence number in a header or an extension header.

25. The method of solution 23, wherein the sequence number is a dedicated sequence number in a header or an extension header.

26. The method of any of solutions 23-25, wherein the user plane function carries the sequence number in a header for the N QoS flows that are one-to-one mapped.

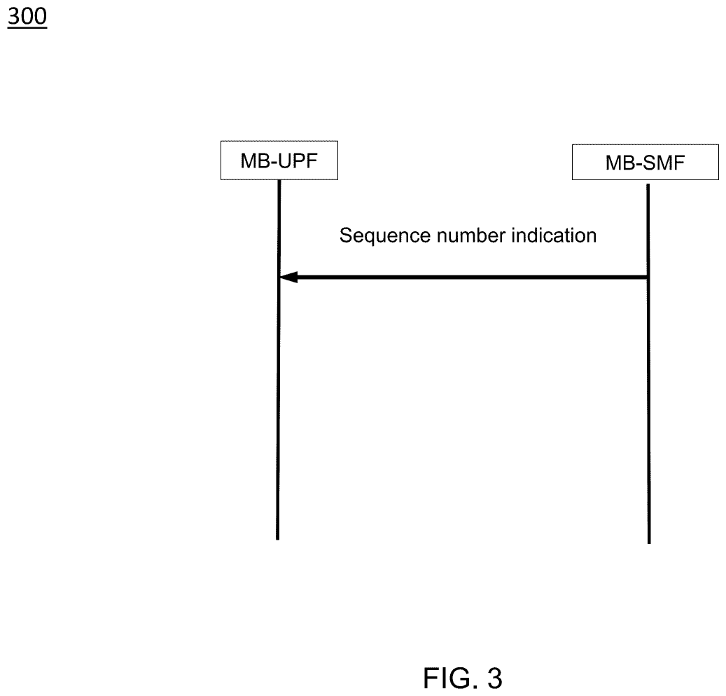

FIG. 3 is a message exchange diagram showing that MB-SMF may communication a sequence number indication to an MB-UPF. Other embodiments and features are disclosed throughout the present document.

For example, an SMF may preferably implement the following solutions.

27. A method of data communication (e.g., method 630 depicted in FIG. 6C), comprising: receiving (632), by a session management function of a wireless network, a configuration from a multicast broadcast session management function, wherein the indication identifies N one-to-one mappings, where N is a positive integer; and operating (634) the session management function according to the configuration.

28. The method of solution 27, wherein each mapping is between a Quality of Service (QoS) flow.

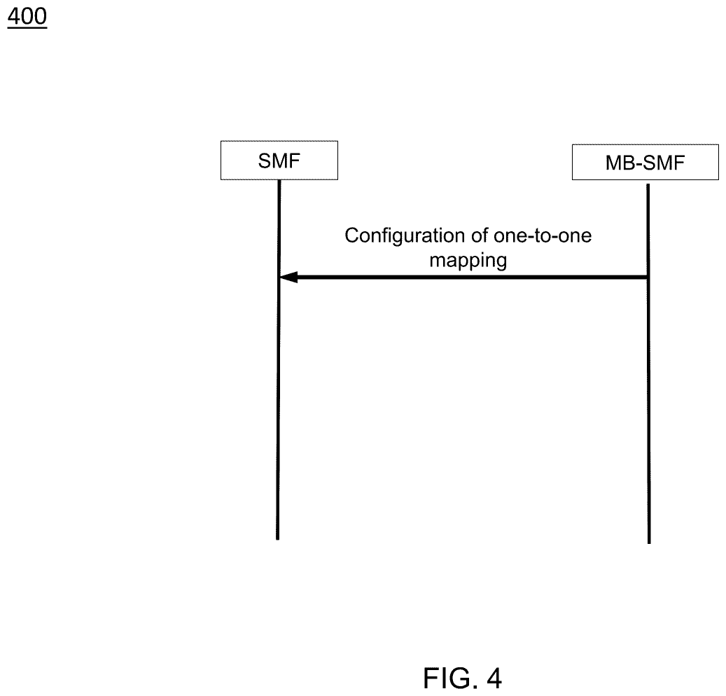

FIG. 4 is a message exchange diagram showing message exchange between SMF and MB-SMF. As disclosed in the present document, the MB-SMF may provide a configuration of one-to-one mapping to the SMF.

30. A data communication apparatus, comprising a processor configured to implement a method recited in any one or more of the above solutions.

31. A computer-readable medium having processor-executable code stored thereupon; the code, upon execution by a processor, causing the processor to implement a method recited in any one or more of above solutions.

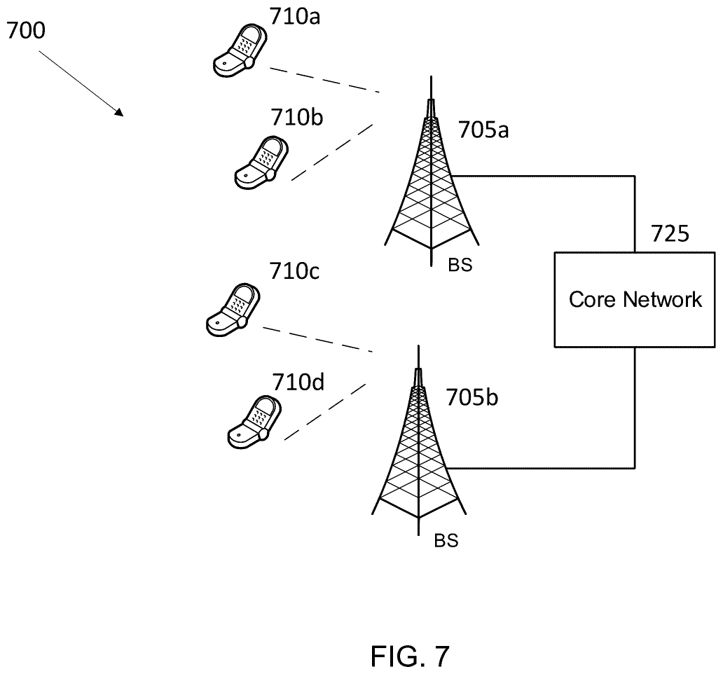

FIG. 7 shows an example of a wireless communication system 700 where techniques in accordance with one or more embodiments of the present technology can be applied. A wireless communication system 700 can include one or more base stations (BSs) 705a, 705b, one or more wireless devices 710a, 710b, 710c, 710d, and a core network 725. A base station 705a, 705b can provide wireless service to wireless devices 710a, 710b, 710c and 710d in one or more wireless sectors. In some implementations, a base station 705a, 705b includes directional antennas to produce two or more directional beams to provide wireless coverage in different sectors.

The core network 725 can communicate with one or more base stations 705a, 705b. The core network 725 provides connectivity with other wireless communication systems and wired communication systems. The core network may include one or more service subscription databases to store information related to the subscribed wireless devices 710a, 710b, 710c, and 710d. A first base station 705a can provide wireless service based on a first radio access technology, whereas a second base station 705b can provide wireless service based on a second radio access technology. The base stations 705a and 705b may be co-located or may be separately installed in the field according to the deployment scenario. The core network may further includes various network-side functions disclosed in the present document (e.g., SMF, MB-SMF, MB-UPF, and so on). The wireless devices 710a, 710b, 710c, and 710d can support multiple different radio access technologies. The techniques and embodiments described in the present document may be implemented by the base stations of wireless devices described in the present document.

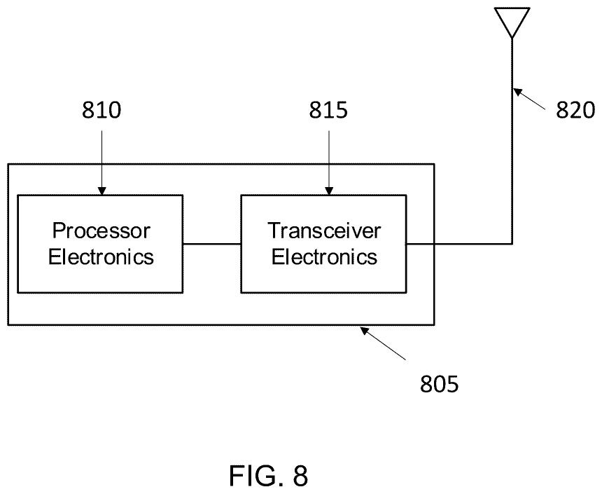

FIG. 8 is a block diagram representation of a portion of a radio station in accordance with one or more embodiments of the present technology can be applied. A radio station 805 such as a base station or a wireless device (or wireless device) can include processor electronics 810 such as a microprocessor that implements one or more of the wireless techniques presented in this document. The radio station 805 can include transceiver electronics 815 to send and/or receive wireless signals over one or more communication interfaces such as antenna 820. The radio station 805 can include other communication interfaces for transmitting and receiving data. Radio station 805 can include one or more memories (not explicitly shown) configured to store information such as data and/or instructions. In some implementations, the processor electronics 810 can include at least a portion of the transceiver electronics 815. In some embodiments, at least some of the disclosed techniques, modules or functions are implemented using the radio station 805. In some embodiments, the radio station 805 may be configured to perform the methods described herein.

In some embodiments, the various network functions (e.g., MB-SMF, SMF, MB-UPF, etc.) may be implemented on a hardware platform that includes a processor and a communication modem. The hardware platform may be similar to radio station 805, with the change that instead of antenna 820 for wireless communication, a wired communication interface may be implemented.

It will be appreciated that the present document discloses techniques that can be embodied in various embodiments to allow a one-to-one mapping being defined for MBS QoS flows and MBS radio bearers. One advantage of such a one-to-one mapping may be that the corresponding resources (e.g., packet numbers) are exclusively used according to the mapping. Another advantage of such a mapping is that a wireless network may be able to keep track of service delivery to/from user devices using a specific sequence number such that lossless handover may be achieved. Other advantages may include reduced retransmission (e.g., for lost packets), and so on. It will further be appreciated that the present document discloses techniques that allow for differently mapping QoS flows to radio bearers—some QoS flows may be mapped using a dedicated pairing with a radio bearer as specified by the core network, while other QoS flows may be mapped according to the determination by a RAN node (e.g., source RAN node).

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

1. A method of data communication, comprising:
receiving, by a user plane function, from a session management function for multicast broadcast services by the user plane function, an indication that the user plane function is to use a general packet radio services tunnel user plane information for a one-to-one mapping between N specified Quality of Service (QoS) flows and N radio bearers for the N QoS flows; and
configuring operation of the user plane function according to the indication.

2. The method of claim 1, wherein the indication is communicated in a multicast broadcast service session control information message.

3. The method of claim 1, wherein the indication specifies that a sequence number is to be used for the one-to-one mapping.

4. The method of claim 3, wherein the sequence number comprises (1) a QOS flow identifier (QFI) sequence number in a header or an extension header, or (2) a dedicated sequence number in the header or the extension header.

5. The method of claim 3, wherein the user plane function carries the sequence number in a header for the N QoS flows that are one-to-one mapped.

6. A method of data communication, comprising:
transmitting, to a user plane function from a session management function for multicast broadcast services by the user plane function, an indication that the user plane function is to use a general packet radio services tunnel user plane information for a one-to-one mapping between N specified Quality of Service (QoS) flows and N radio bearers for the N QoS flows.

7. The method of claim 6, wherein the indication is communicated in a multicast broadcast service session control information message.

8. The method of claim 6, wherein the indication specifies that a sequence number is to be used for the one-to-one mapping.

9. The method of claim 8, wherein the sequence number comprises (1) a QOS flow identifier (QFI) sequence number in a header or an extension header, or (2) a dedicated sequence number in the header or the extension header.

10. The method of claim 8, wherein the user plane function carries the sequence number in a header for the N QoS flows that are one-to-one mapped.

11. An apparatus for implementing a user plane function, the apparatus comprising a processor and a memory storing instructions, execution of which by the processor causing the apparatus to:
receive, from a session management function for multicast broadcast services by the user plane function, an indication that the user plane function is to use a general packet radio services tunnel user plane information for a one-to-one mapping between N specified Quality of Service (QoS) flows and N radio bearers for the N QoS flows; and
configure operation of the user plane function according to the indication.

12. The apparatus of claim 11, wherein the indication is communicated in a multicast broadcast service session control information message.

13. The apparatus of claim 11, wherein the indication specifies that a sequence number is to be used for the one-to-one mapping.

14. The apparatus of claim 13, wherein the sequence number comprises (1) a QOS flow identifier (QFI) sequence number in a header or an extension header, or (2) a dedicated sequence number in the header or the extension header.

15. The apparatus of claim 13, wherein the user plane function carries the sequence number in a header for the N QoS flows that are one-to-one mapped.

16. An apparatus for implementing a session management function, the apparatus comprising a processor and a memory storing instructions, execution of which by the processor causing the apparatus to:
transmitting, to a user plane function for multicast broadcast services by the user plane function, an indication that the user plane function is to use a general packet radio services tunnel user plane information for a one-to-one mapping between N specified Quality of Service (QoS) flows and N radio bearers for the N QoS flows.

17. The apparatus of claim 16, wherein the indication is communicated in a multicast broadcast service session control information message.

18. The apparatus of claim 16, wherein the indication specifies that a sequence number is to be used for the one-to-one mapping.

19. The apparatus of claim 18, wherein the sequence number comprises (1) a QOS flow identifier (QFI) sequence number in a header or an extension header, or (2) a dedicated sequence number in the header or the extension header.

20. The apparatus of claim 18, wherein the user plane function carries the sequence number in a header for the N QoS flows that are one-to-one mapped.
